(19) United States
(12) Patent Application Publication
(10) Pub. No.: US 2026/0352447 A1
(43) Pub. Date: Nov. 5, 2026

(54) TRANSPORT LAYER SECURITY SESSION PROTOCOL WITH KEYED INITIATION

(71) Applicant: Wells Fargo Bank, N.A., San Francisco, CA (US)

(72) Inventor: Nicola Anthony Maiorana, Charlotte, NC (US)

(21) Appl. No.: 19/742,023

(22) Filed: Jul. 15, 2026

Related U.S. Application Data
(63) Continuation of application No. 19/027,638, filed on Jan. 17, 2025.

(51) Int. Cl. H04L 9/08; H04L 9/32

(52) U.S. Cl. CPC H04L 9/0825; H04L 9/0866; H04L 9/3263

(57) ABSTRACT

Transport Layer Security (TLS) session initiation protocol with enhanced security. The protocol can be implemented to establish a secure communication session between a server device and a client device over a data network. The protocol begins with a Hello message sent from the client device to the server device. The Hello message includes a header with a TLS payload that is encrypted with a client-specific private portion of an initiation key. A legitimate server device has access to the public portion of the initiation key in order to decrypt the TLS header and continue with the handshake.

### BACKGROUND

Transport Layer Security (TLS) is a security protocol that encrypts data and verifies the identities of parties, such as a client device and a server device, communicating over a data network. Among other applications, TLS is used to protect data integrity and privacy between web browsers on the client side, and web servers on the server side, as well as to provide secure communications via web-based electronic mail. TLS is designed to create a secure connection between a client and a server through a multistep process called a TLS handshake. During this process, the client device authenticates the server device, and the two devices exchange a shared secret for communication.

### SUMMARY

Examples provided herein are directed to Transport Layer Security communication session protocols with one or more enhanced security features.

According to one aspect, the present disclosure relates to a method of establishing a communication session between a client device and a server device over a data network, including: prior to receiving any handshake message for the communication session from the server device, transmitting by the client device to the server device a client hello handshake message to initiate a Transport Layer Security (TLS) handshake between the client device and the server device, the client hello handshake message including a client hello header and a client hello payload, the client hello header including: a private portion of an initiation key, the private portion of the initiation key being specific to the client device; and a client TLS payload, the client TLS payload including a data packet encrypted with the private portion of the initiation key.

According to another aspect, the present disclosure relates to a method of establishing a communication session between a client device and a server device over a data network, including: prior to transmitting any handshake message for the communication session by the server device, receiving by the server device a client hello handshake message from the client device to initiate a Transport Layer Security (TLS) handshake between the client device and the server device, the client hello handshake message including a client hello header and a client hello payload, the client hello header including: a private portion of an initiation key, the private portion of the initiation key being specific to the client device; and a client TLS payload, the client TLS payload including a data packet encrypted with the private portion of the initiation key; matching, by the server device, the private portion of the initiation key to a public portion of the initiation key, the public portion of the initiation key being specific to the client device; and decrypting, by the server device, the data packet using the public portion of the initiation key.

According to another aspect, the present disclosure relates to a system for establishing a communication session over a data network, including: a server device; a client device; processors; and non-transitory computer-readable storage media encoding instructions which, when executed by the processors, causes the system to: transmit, by the client device to the server device, a client hello handshake message to initiate a Transport Layer Security (TLS) handshake between the client device and the server device, the client hello handshake message including a client hello header and a client hello payload, the client hello header including: a private portion of an initiation key, the private portion of the initiation key being specific to the client device; and a client TLS payload, the client TLS payload including a data packet encrypted with the private portion of the initiation key; match, by the server device, the private portion of the initiation key to a public portion of the initiation key, the public portion of the initiation key being specific to the client device; decrypt, by the server device, the data packet using the public portion of the initiation key; transmit, by the server device to the client device and in response to the client hello handshake message, a server hello handshake message, the server hello handshake message including a server hello header and a server hello payload, the server hello header including a server TLS payload, the server TLS payload including another data packet encrypted with the public portion of the initiation key; decrypt, by the client device, the another data packet; authenticate the server device, by the client device, based on the another data packet; generate, by the client device, a secret; generate, by the server device, the secret; generate, by the client device, a session key using the secret; generate, by the server device, the session key using the secret; and exchange the session key between the client device and the server device to establish the communication session.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows an example system for executing a TLS session protocol with keyed initiation.

FIG. 2 schematically shows a communication diagram illustrating components of an example TLS handshake protocol.

FIG. 3 schematically shows a communication diagram illustrating an example Man-in-the-Middle (MITM) attack during a TLS handshake protocol.

FIG. 4 schematically shows a communication diagram illustrating components of an example TLS handshake protocol that can be performed using the system of FIG. 1.

FIG. 5 schematically shows example components of a data packet that can be generated by the system of FIG. 1.

FIG. 6 schematically shows example components of another data packet that can be generated by the system of FIG. 1.

FIG. 7 schematically shows another example method that can be performed using the system of FIG. 1.

FIG. 8 shows example physical components of one or more devices of the system of FIG. 1.

### DETAILED DESCRIPTION

This disclosure relates to security enhancements in Transport Layer Security (TLS) communication handshake protocols between computing devices, such as between a client device and a server device. The security enhancements relate to cryptographic keys used in the TLS handshake process to encrypt handshake header data. A cryptographic key is a secret string of data used to encrypt, decrypt, authenticate, and authorize data in a cryptographic algorithm. Cryptographic keys are random strings of characters that can be used to scramble plain text into cipher text, and then back again via decryption.

TLS is a protocol used to encrypt and protect application data flowing across a data network, such as the internet. TLS allows a client device and a server device to share cryptographic keys to encrypt and digitally sign messages being transmitted over a network connection.

TLS is used to provide secure communication and protect vulnerable protocols such as Hypertext Transfer Protocol (HTTP). HTTP that is enhanced with TLS can be referred to as Hypertext Transfer Protocol Secure (HTTPS). Another example context in which TLS can be employed is remote access virtual private networks (VPNs).

A weakness of the TLS protocol is that it cannot protect from certain Man-in-the-Middle (MITM) attack scenarios.

In an example MITM scenario, an attacker (e.g., a bad actor) impersonates a legitimate website. In one of many possible MITM mechanisms, the user of the client device is deceived into navigating to an attacker's version of a legitimate website hosted on the MITM server. In this scenario, the TLS is rendered ineffective since the MITM server impersonates the legitimate server to the user, and impersonates the user to the legitimate server. This allows the MITM server to establish a TLS connection with both the user and the legitimate server, with the ability to see all the data traffic between the user and the legitimate website without encryption.

In another mechanism, the MITM simply intercepts (e.g., via a public Wi-Fi network), the client device's initial TLS handshake that it sends to a legitimate website and proceeds to impersonate the legitimate website server to the client device, and to impersonate the client device to the legitimate website server, allowing the MITM device to see all data travelling between the client and the legitimate server unencrypted.

The present disclosure can provide one or more technological solutions to various MITM scenarios, as well as other security risks. These technical solutions include cryptographic enhancements to the handshake messages exchanged between the client device and the server device, as described in more detail herein. The cryptographic enhancements can serve to hide any TLS handshake artifacts from a MITM server or other MITM device. As a result, instead of passing the “Client Hello” message from the client device to the server device without encryption, a TLS session client-specific initiation key is used to encrypt the “Client Hello” message. The server device then looks up the public portion of the session initiation key and encrypts any sensitive payload back to the client in the “Server Hello” message response. Since any MITM device would not have access to the client-specific initiation key, the MITM device has no way to impersonate the client or the server going forward during the communication session.

The TLS session client-specific initiation key described herein is an example of one of the technological solutions and improvements in specific areas of technology, such as TLS protocols and computational cryptography, which are described in more detail herein. These technological solutions constitute, at least in some examples, improvements in the functioning of computing devices in that, for instance, computing devices are made less vulnerable to one or more types of malicious attacks and security breaches

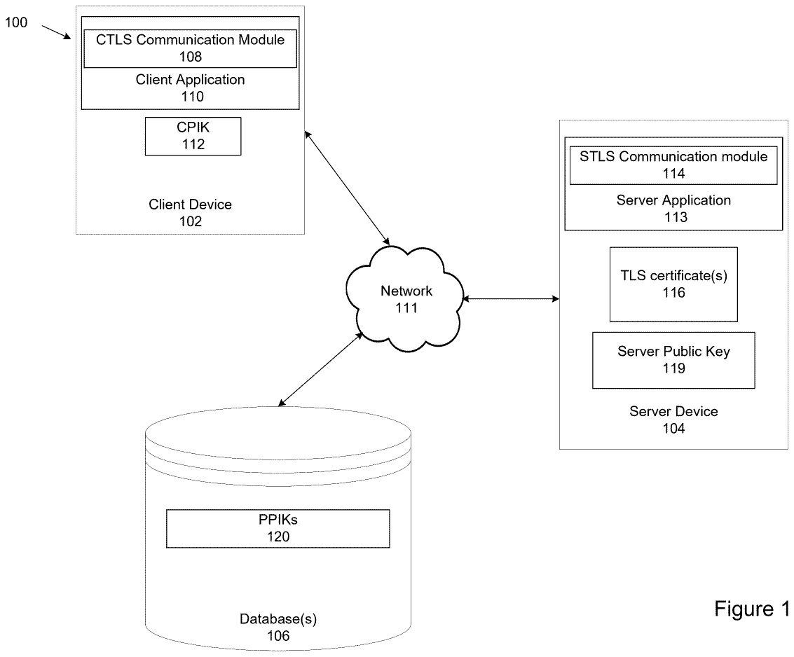

FIG. 1 schematically shows an example system 100 for executing a TLS session protocol with keyed initiation.

The system 100 includes a client device 102, a server device 104 and a database 106 that communicate over a data network 111. In some examples, the computing devices 102, 104 and the database 106 are physically remote from one another.

The client device 102 can be associated with an end user of a computing application, such as a web browser or a virtual private network (VPN) application. The client device 102 stores a client application 110 that can correspond to such a computing application. The client device 102 can be any suitable computing device for a user, such as a smartphone, a tablet, desktop computer, laptop computer, a smartwatch or other wearable computing technology, and the like.

The server device 104 can be associated with any enterprise that provides backend functionality for the client application 110. The server device 104 stores a server application 113 that can correspond to the client application 110 and provides backend functionality for the client application 110. For example, the server device 104 can host a website that a user seeks to navigate to and browse via the client application 110. The system 100 can include one or more application programming interfaces (APIs) to enable interfacing and integration of the frontend software run by the client application 110 and the backend software run by the server application 113. Such APIs can be stored on the server device 104, the client device 102, or both. For example, such APIs can be installed as plug-ins to one or more of the client application 110 and the server application 113.

The server device 104 stores one or more TLS certificate(s) 116. A TLS certificate 116 is sent to the client device 102 during the TLS handshake process. For a legitimate server device 104, a reputable certificate agent issues the TLS certificate, with information identifying the certificate agent typically included in the TLS certificate 116. The TLS certificate 116 is used by the client device 102 (e.g., by the client application 110) to verify that the computing device 102 is communicating with a legitimate server.

The server device 104 stores a server public key 119. Alternatively, the server public key 119 can be stored on the database(s) 106. The server public key 119 is accessed by the client device 102 during the TLS handshake process to decrypt a message data payload sent by the server device 104. The server public key 119 can uniquely identify the server device 104.

The client device 102 stores a client portion of an initiation key (CPIK) 112. The CPIK 112 is specific (e.g., unique) to the client device 102. For example, the CPIK 112 can be identical to, a function of, or otherwise based on, the Internet Protocol (IP) address, or another device specific identifier, of the client device 120.

The CPIK 112 is used by the client TLS (CTLS) communication module 108 to encrypt data sent to the server device 104 in the header of a handshake Hello message to initiate a TLS handshake process between the client device 102 and the server device 104.

The CTLS communication module 108 can be included in the client application 110, e.g., as a software plugin to the client application 110, or otherwise stored and run by the client device 102. The CTLS communication module 108 is configured to generate TLS handshake packets that are transmitted to the server device 104 via the data network 111 to establish a TLS communication session between the client application 110 and the server application 113.

The server TLS (STLS) communication module 114 is configured to generate TLS handshake packets that are transmitted to the client device 102 via the data network 111 during a TLS handshake protocol initiated by the client device 102 to establish a TLS communication session between the client application 110 and the server application 113. The STLS communication module 114 can be included in the server application 113, e.g., as a software plug-in to the server application 113, or otherwise stored and run by the client device 102.

The database(s) 106 stores public portions of initiation keys (PPIKs) 120 of various different client devices. Each PPIK 120 corresponds, one-to-one, with a single CPIK. Thus, while the system 100 depicts just one client device 102, in other examples, the system can include many client devices (e.g., hundreds, thousands, millions, or even billions) of client devices that may wish to access some functionality (e.g., a website) provided by the server application 113. Each such client device can include its own, unique CPIK that corresponds to its own unique PPIK 120.

Each legitimate server linked to the network 111, such as the server device 104, is given authorized access to CPIKs (or CPIK identifiers) that it receives and to look up the PPIK 120 corresponding to a given CPIK, in response to receiving a TLS Hello message header that is encrypted with a CPIK, such as the CPIK 112.

The STLS communication module 114 then uses the looked up corresponding PPIK 120 to decrypt the encrypted Hello message header and thereby proceed with the TLS handshake protocol.

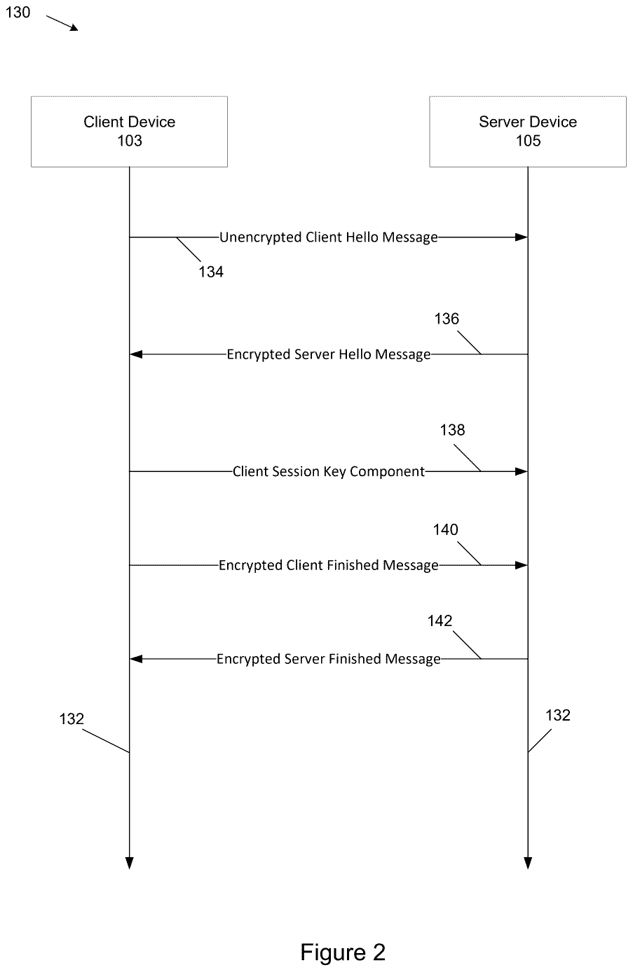

FIG. 2 schematically shows a communication diagram 130 illustrating components of an example TLS handshake protocol between a client device 103 and a server device 105, in which the TLS handshake protocol does not incorporate CPIK and PPIK security enhancements. The handshake may include additional steps of data transmission between the client device 103 and the server device 105 other than the ones that are shown.

In FIG. 2, time progresses in the direction of the arrows 132. The time-distance along the arrows 132 between data transmissions depicted in FIG. 2 is not necessarily to scale.

The handshake is initiated with an unencrypted client Hello message 134 sent from the client device 103 to the server device 105. The client Hello message 134 can include, for instance, the highest version of TLS that the client device 103 can support, a list of cipher suites that the client device 103 can support, and a client random number.

In response to the client Hello message 134, the server device transmits an encrypted server Hello message 136. The server Hello message can include a chosen TLS version and chosen cipher suites for the communication session, based on the client device's capabilities as defined in the client Hello message 134. The server Hello message can also include a server random number, server-side session key components which are parameters used by the client device 103 and the server device 105 to generate symmetrical session key unique to the communication session being initiated, a copy of the server's TLS certificate issued by a certificate agent, and the server's digital signature.

The client device 103 then authenticates the server device 105 by checking the certificate agent that issued the server certificate. The client device 103 also decrypts the server's digital signature using the server public key 119 (FIG. 1), thereby verifying that the server is legitimate.

Once the client device 103 verifies the purported legitimacy of the server device 105, the client device 103 transmits one or more client-side session key component(s) 138 which is/are one or more further parameters used by the client device 103 and the server device 105 to generate the symmetrical session key that will be unique to the communication session being initiated.

Both the client device 103 and the server device 105 then separately generate the same secret using the client-side session key component(s) 138 and the server side session key component(s).

Both the client device 103 and the server device 105 then generate the same symmetrical session key using the client random number, the server random number, and the secret.

The client device 103 then transmits an encrypted Finished message 140 encrypted with the session key and the server device 105 transmits an encrypted Finished message 142 encrypted with the session key, thereby completing the TLS handshake and opening the communication session for which both the client device 103 and the server device 105 will use the session key going forward to encrypt and decrypt data sent between the devices.

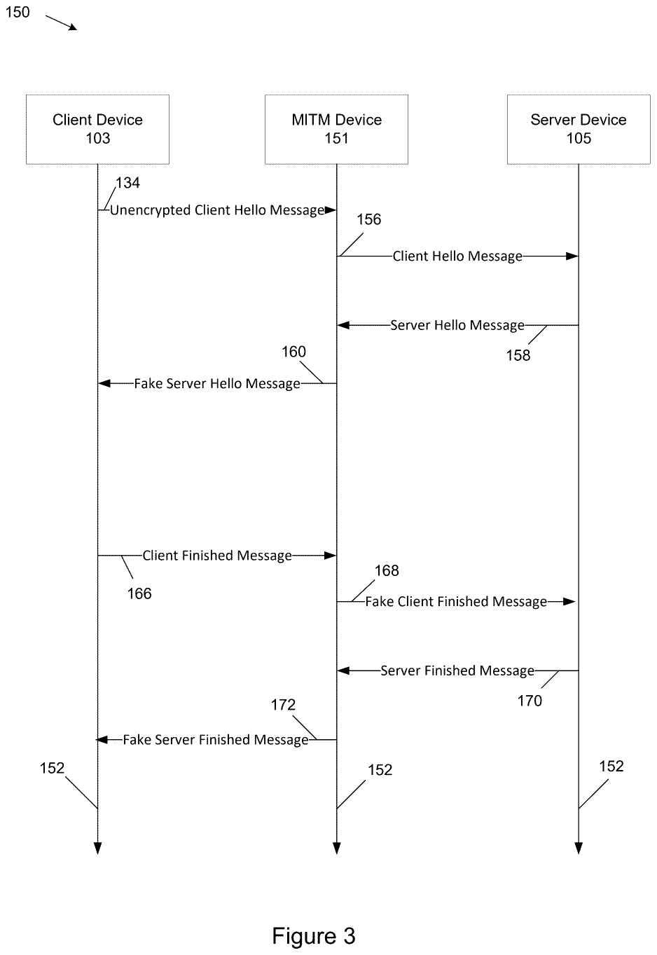

FIG. 3 schematically shows a communication diagram 150 illustrating an example Man-in-the-Middle (MITM) attack during a TLS handshake protocol between the client device 103 and the server device 105. The handshake may include additional steps of data transmission between the client device 103 and the server device 105 other than the ones that are shown.

In FIG. 3, time progresses in the direction of the arrows 152. The time-distance along the arrows 152 between data transmissions depicted in FIG. 3 is not necessarily to scale.

Referring to FIG. 3, the handshake is initiated by the client device 103 when it transmits the unencrypted client Hello message 134. The message 135 is intercepted by the MITM device 151, which is a non-legitimate server that maliciously seeks to read the data flow between the client device 103 and the server device 105. The MITM device 151 learns from the unencrypted client Hello message 134 the TLS version, cipher suite and other parameters that the client device 103 can support for establishing a TLS communication session with the client device 103.

The MITM device 151 then sends its own client Hello message 156 to the server device 105, impersonating the client device 103.

The server device 105 then replies with the server Hello message 158 and its TLS certificate, which are intercepted by the MITM device 151. This enables the MITM device 151 to access the public key of the server device 105.

The MITM device 151 then impersonates the server device 104 to the client device 103 by sending a fake server Hello message 160 and fake TLS certificate to the client device 103. The fake server Hello message 160 provides the client device 103 with the MITM device's public key rather than the server device's public key, as well as the TLS certificate of the server device 105. The client device 103 then looks up and verifies the server device 105 using its TLS certificate, when in actuality it is verifying the MITM device 151.

Meanwhile, the MITM device 151 computes a secret using the public key of the server device 105.

The client device 103 also computes a secret, with the public key it believes to be from the server but that is actually from the MITM device 151.

The computed secret of the client device 103 is sent to the MITM device 151 and the computed secret of the MITM device 151 is sent to the server device 105.

With the client Finished message 166 from the client device 103 to the MITM device 151, the ensuing fake client Finished message 168 from the MITM device 151 to the server device 105, the server Finished message 170 from the server device 105 to the MITM device 151, and the ensuing fake server Finished message 172 from the MITM device 151 to the client device 103, the MITM device 151 and the client device 103 thereby create one session key using their computed secret, while the MITM device 151 and the server device 105 thereby create another session key using their computed secret.

The MITM device 151 now has two different sessions keys that it uses to impersonate the server device 105 to the client device 103, and to impersonate the client device 103 to the server device 105 going forward with the communication session.

With the handshake complete and the TLS communication session initiated, the MITM device 151 uses the two different session keys to decrypt and thereby read the communications from the client device 103 to the server device 105 (using one of the session keys) and to decrypt and thereby read the communication from the server device 105 to the client device 103 (using the other of the session keys). Meanwhile, the client device 103 and the server device 105 believe they are in a secure TLS communication with each other.

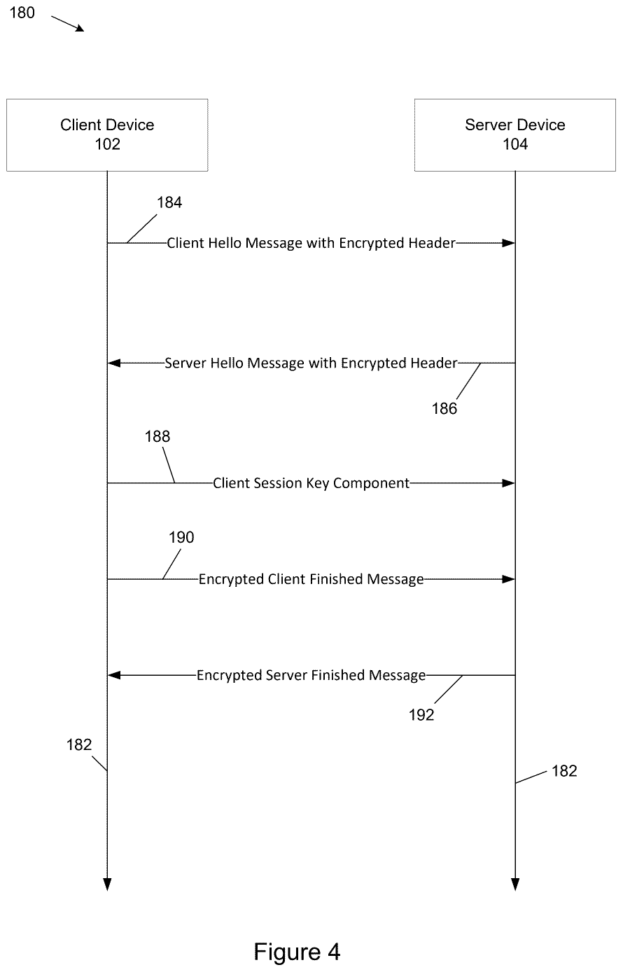

FIG. 4 schematically shows a communication diagram 180 illustrating components of an example TLS handshake protocol that can be performed using the system of FIG. 1. The method 180 depicts a TLS handshake protocol between the client device 102 and the server device 104 of FIG. 1 with enhanced security functionality as compared with the TLS handshake protocols of FIGS. 2 and 3. The enhanced security functionality is provided, at least in part, by the CTLS communication module 108 and the STLS communication module 114 (FIG. 1). The enhanced security functionality can, for example, reduce the likelihood of a MITM attack such as the MITM attack described in reference to FIG. 3.

The TLS handshake of FIG. 4 may include additional steps of data transmission between the client device 102 and the server device 104 other than the ones that are shown.

In FIG. 4, time progresses in the direction of the arrows 182. The time-distance along the arrows 152 between data transmissions depicted in FIG. 4 is not necessarily to scale.

The handshake is initiated with an encrypted client Hello message 184 sent from the client device 102 to the server device 104. The client Hello message 134 can include, for instance, the highest version of TLS that the client device 102 can support, a list of cipher suites that the client device 102 can support, and a client random number. Some or all of this data, other data included with the client Hello message, is encrypted with the CPIK 112 (FIG. 1).

Since only legitimate server devices (such as the server device 104) can access CPIKs (or CPIK identifiers) to match them to the corresponding PPIKs 120 (FIG. 1), any MITM server device would be incapable of looking up the corresponding PPIK in order to decrypt the client Hello message 184. Since the MITM server device is incapable of decrypting the client Hello message 184, it is unable to impersonate the client device 102, and thereby cannot complete the handshake as a MITM to read the data flowing between the client device 102 and the server device 104 going forward once the communication session is established.

In response to the encrypted client Hello message 184, the server device 104 looks up the PPIK corresponding to the CPIK (or CPIK identifier) received in the transmitted client Hello message 184 and used the PPIK to decrypt the encrypted header of the client Hello message 184.

The server device 104 then transmits a server Hello message 186 with a header encrypted with the PPIK that the server device 104 had identified.

The server Hello message 186 can include, encrypted by the identified PPIK, a chosen TLS version and chosen cipher suites for the communication session, based on the client device's capabilities as defined in the client Hello message 184. The server Hello message can also include a server random number, server-side session key components, which are further parameters used by the client device 102 and the server device 104 to generate symmetrical session key unique to the communication session being initiated, a copy of the server's TLS certificate issued by a certificate authority, and the server's digital signature. In examples, some or all of this data can be encrypted with the PPIK and/or the server public key 119 (FIG. 1).

The client device 102 then authenticates the server device 104 by checking the certificate agent that issued the server certificate. The client device 102 also decrypts the server's digital signature using the server public key 119 (FIG. 1), thereby verifying that the server is legitimate.

Once the client device 102 verifies the legitimacy of the server device 104, the client device 102 transmits one or more client-side session key component(s) 188 which is/are one or more further parameters used by the client device 102 and the server device 104 to generate the symmetrical session key that will be unique to the communication session being initiated.

Both the client device 102 and the server device 104 then separately generate the same secret using the client-side session key component(s) 188 and the server-side session key component(s).

Both the client device 102 and the server device 104 then generate the same symmetrical session key using the client random number, the server random number, and the secret.

The client device 102 then transmits an encrypted Finished message 190 encrypted with the session key and the server device 104 transmits an encrypted Finished message 192 encrypted with the session key, thereby completing the TLS handshake and opening the communication session for which both the client device 102 and the server device 104 will use the session key going forward to encrypt and decrypt data sent between the devices.

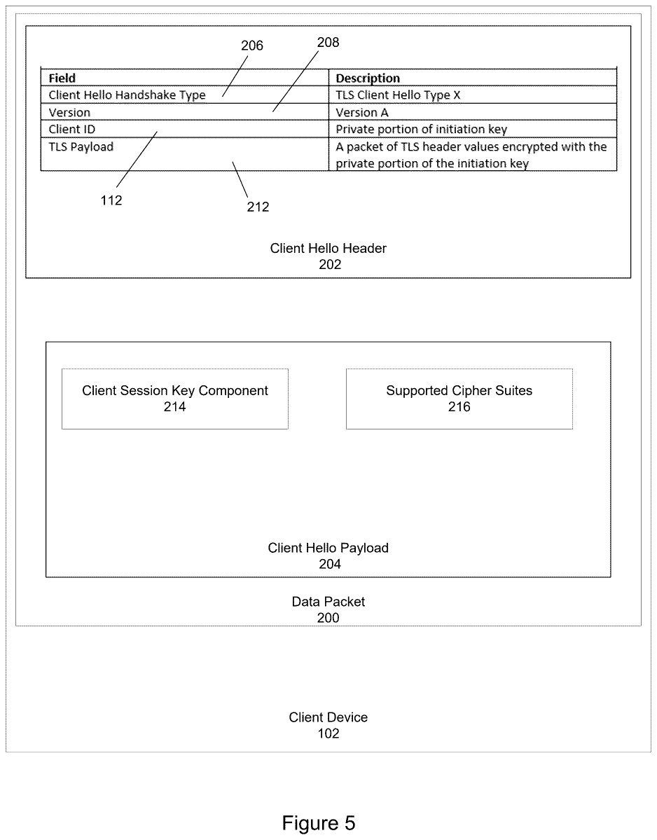

FIG. 5 schematically shows example components of a data packet 200 that can be generated by the system 100 of FIG. 1.

The data packet 200 is generated by the client device 102.

In some examples, the data packet 200 corresponds to the client Hello message 184 (FIG. 4).

The data packet 200 includes a client Hello header 202 and a client Hello payload 204. The header includes data fields that define and/or include, the type of Hello handshake 206, the TLS version 208 to be used for the handshake, the CPIK 112 or CPIK identifier, and a client-side TLS payload 212.

The client-side TLS payload 212 can be a packet of other TLS header values that define the specific TLS protocol parameters that will govern the handshake and/or the ensuing communication session.

The client-side TLS payload 212 is encrypted with the CPIK 112 that only legitimate server devices, such as the server device 104, can access and look up the corresponding PPIK.

The client Hello payload 204 includes a client session key component 214 and a list of cipher suites 216 that are supported by the client device 102 for purposes of the requested TLS communication session. The client session key component 214 can be one or more parameters used by the client device 102 and the server device 104 to generate a secret, which itself is used to a generate symmetrical session key unique to the communication session being initiated. The session key is used following the handshake protocol to encrypt and decrypt messages between the client device 102 and the server device 104 only during the established TLS communication session.

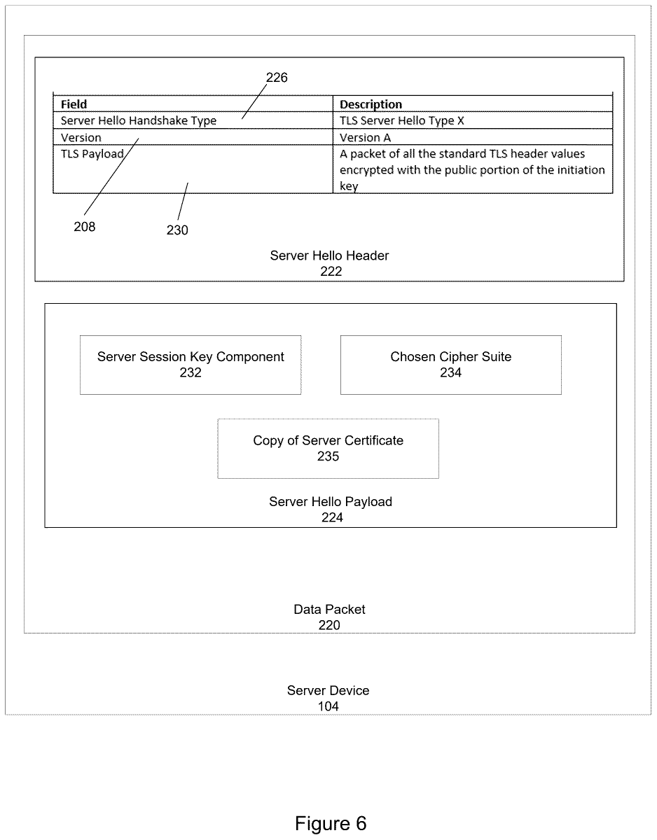

FIG. 6 schematically shows example components of a data packet 220 that can be generated by the system 100 of FIG. 1.

The data packet 220 is generated by the server device 104.

In some examples, the data packet 220 corresponds to the server Hello message 186 (FIG. 4).

The data packet 220 includes a server Hello header 222 and a server Hello payload 224. The header includes data fields that define and/or include, the type of Hello handshake 226, the TLS version 208 to be used for the handshake, and a server-side TLS payload 230.

The server-side TLS payload 230 can be a packet of other TLS header values that define the specific TLS protocol parameters that govern the handshake and/or the ensuing communication session.

The server-side TLS payload 230 is encrypted with the PPIK corresponding to the CPIK or CPIK identifier that was received in the client Hello message.

The server Hello payload 224 includes a server session key component 232, the chosen cipher suite 234 chosen by the server device 104 for this communication session from the list of cipher suites 216, and a copy of the server certificate 235. The server session key component 232 can be one or more parameters used by the client device 102 and the server device 104 to generate the secret, which itself is used to a generate the symmetrical session key unique to the communication session being initiated. The session key is used following the handshake protocol to encrypt and decrypt messages between the client device 102 and the server device 104 only during the established TLS communication session.

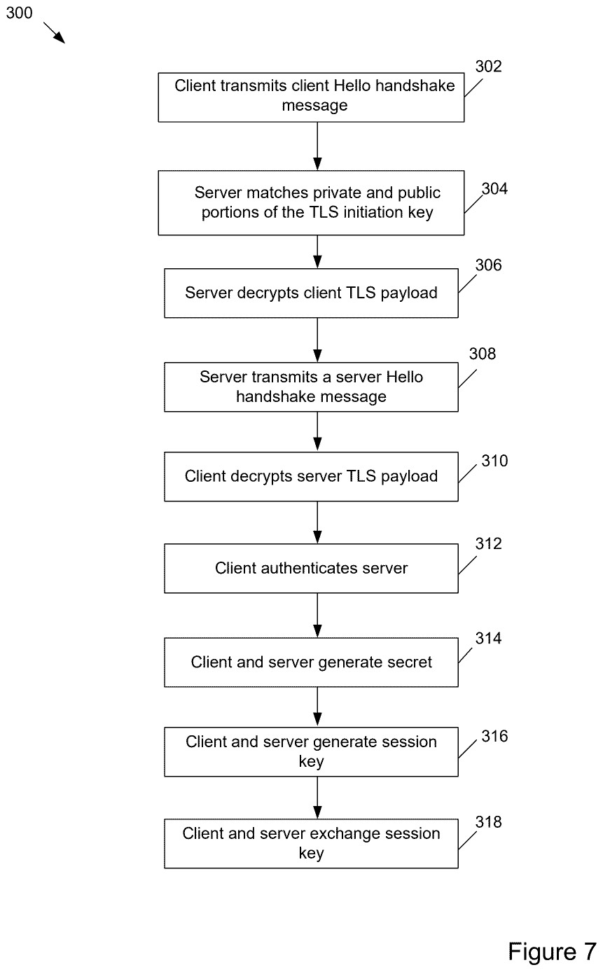

FIG. 7 schematically shows another example method 300 that can be performed using the system 100 of FIG. 1. The method 300 illustrates a TLS handshake protocol between a client device and a server device. The method 300 may include more or fewer steps than the steps that are depicted. In addition, the depicted steps need not be performed in the depicted order.

At a step 302 of the method 300, a client device transmits a client Hello handshake message.

At a step 304 of the method 300, based on the client Hello handshake message, the server device matches private and public portions of a TLS initiation key.

At a step 306 of the method 300, the server device decrypts the TLS payload of the client Hello handshake message, e.g., using the public portion of the TLS initiation key.

At a step 308 of the method 300, the server device, transmits a server Hello handshake message to the client device.

At a step 310 of the method 300, the client device decrypts the server TLS payload.

At a step 312 of the method 300, the client device authenticates the server.

At a step 314 of the method 300, the client device and server device independently generate a secret for their communication session.

At a step 316 of the method 300, the client device and server device independently generate a session key for their communication session using the secret.

At a step 318 of the method 300, the client device and server device exchange the session key, thereby completing the handshake and opening the communication session in which the messages are exchanged between the client device and the server device and are encrypted and decrypted using the session key.

### Computing Architecture

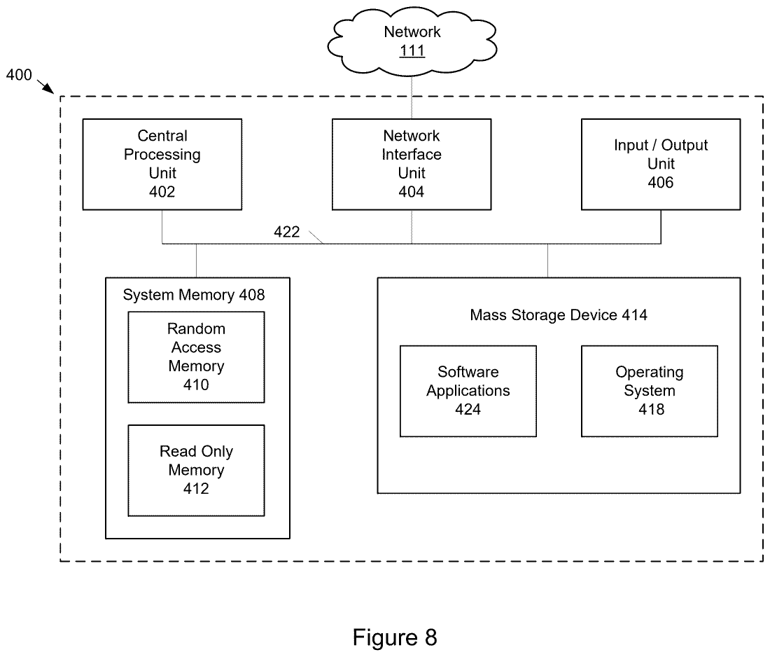

Additional components of the system 100 of FIG. 1 are illustrated in FIG. 8.

The electronic computing device 400 can correspond to any of the client device 102 and the server device 104 of the system 100 of FIG. 1. Components of the computing device 400 can correspond to other components of the system 100 of FIG. 1, such as the database(s) 106.

When the computing device 400 corresponds to the server device 104, the computing device 400 can be an internally controlled and managed device (or multiple devices) of an enterprise. Alternatively, the computing device 400 can represent one or more devices operating in a shared computing system external to the enterprise, such as a cloud.

As illustrated in the embodiment of FIG. 8, the example computing device 400, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the computing device 400, such as during startup, is stored in the ROM 412. The computing device 400 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the computing device 400. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 400.

According to various embodiments of the invention, the computing device 400 may operate in a networked environment using logical connections to remote network devices through network 111, such as a wireless network, the Internet, an NFC network, or another type of network, or combination of networks. The computing device 400 may connect to a network 111 through a network interface unit 404 connected to the system bus 422. It should be appreciated that the network interface unit 404 may also be utilized to connect to other types of networks and remote computing systems. The computing device 400 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the computing device 400 can store software instructions and data. The software instructions include an operating system 418 suitable for controlling the operation of the computing devices of the system 100. The mass storage device 414 and/or the RAM 410 also store software instructions and applications 424, that when executed by the CPU 402, cause the computing device 400 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method of establishing a communication session between a client device and a server device over a data network, comprising:
initiating a Transport Layer Security (TLS) handshake between the client device and the server device by receiving, by the server device, a client hello handshake message, the client hello handshake message including:
a private portion of an initiation key, the private portion of the initiation key being specific to the client device; and
a client TLS payload, the client TLS payload including a data packet encrypted with the private portion of the initiation key.

2. The method of claim 1, wherein the client hello handshake message includes a header that defines a TLS version and a type of the client hello handshake message.

3. The method of claim 2, wherein the data packet defines a size of a client hello payload of the client hello handshake message.

4. The method of claim 3, wherein the client hello payload includes a client session key component.

5. The method of claim 4, wherein the client hello payload identifies one or more cipher suites supported by the client device.

6. The method of claim 1, wherein the client hello handshake message is generated using a web browser application installed on the client device.

7. The method of claim 1, wherein the private portion of the initiation key is stored on the client device.

8. The method of claim 1, further comprising:
matching, by the server device, the private portion of the initiation key to a public portion of the initiation key, the public portion of the initiation key being specific to the client device; and
decrypting, by the server device, the data packet using the public portion of the initiation key.

9. The method of claim 8, further comprising:
transmitting, by the server device to the client device and in response to the client hello handshake message, a server hello handshake message, the server hello handshake message including another data packet encrypted with the public portion of the initiation key.

10. The method of claim 9,
wherein the server hello handshake message includes a server session key component and a copy of a server digital certificate, the server session key component being selected based on one or more cipher suites supported by the client device and identified in the client hello handshake message; and
wherein the method further comprising:
receiving, by the server device from the client device, a client session key component; and
generating, by the server device, a secret using the server session key component and the client session key component.

11. A system for establishing a communication session over a data network, comprising:
one or more processors; and
non-transitory computer-readable storage media encoding instructions which, when executed by the one or more processors, causes the system to:
initiate a Transport Layer Security (TLS) handshake between a client device and a server device by receiving, by the server device, a client hello handshake message, the client hello handshake message including:
a private portion of an initiation key, the private portion of the initiation key being specific to the client device; and
a client TLS payload, the client TLS payload including a data packet encrypted with the private portion of the initiation key.

12. The system of claim 11, wherein the client hello handshake message includes a header that defines a TLS version and a type of the client hello handshake message.

13. The system of claim 12, wherein the data packet defines a size of a client hello payload of the client hello handshake message.

14. The system of claim 13, wherein the client hello payload includes a client session key component.

15. The system of claim 14, wherein the client hello payload identifies one or more cipher suites supported by the client device.

16. The system of claim 11, wherein the client hello handshake message is generated using a web browser application installed on the client device.

17. The system of claim 11, wherein the private portion of the initiation key is stored on the client device.

18. The system of claim 11, wherein the non-transitory computer-readable storage media encodes further instructions which, when executed by the one or more processors, causes the system to:
match, by the server device, the private portion of the initiation key to a public portion of the initiation key, the public portion of the initiation key being specific to the client device; and
decrypt, by the server device, the data packet using the public portion of the initiation key.

19. The system of claim 18, wherein the non-transitory computer-readable storage media encodes further instructions which, when executed by the one or more processors, causes the system to:
transmit, by the server device to the client device and in response to the client hello handshake message, a server hello handshake message, the server hello handshake message including another data packet encrypted with the public portion of the initiation key.

20. The system of claim 19,
wherein the server hello handshake message includes a server session key component and a copy of a server digital certificate, the server session key component being selected based on one or more cipher suites supported by the client device and identified in the client hello handshake message; and
wherein the non-transitory computer-readable storage media encodes further instructions which, when executed by the one or more processors, causes the system to:
receive, by the server device from the client device, a client session key component; and
generate, by the server device, a secret using the server session key component and the client session key component.
